(19) United States
(12) Patent Application Publication
(10) Pub. No.: US 2012/0298769 A1
(43) Pub. Date: Nov. 29, 2012

(54) Synthetic Jet Ejector With Sealed Motor

(75) Inventors: Samuel N. Heffington, Austin, TX (US); Markus Schwickert, Austin, TX (US); Stephen P. Darbin, Austin, TX (US); Daniel N. Grimm, Round Rock, TX (US); Donald G. Doss, Austin, TX (US); Raghavendran Mahalingam, Austin, TX (US); Curtis A. Frodge, Austin, TX (US); John Stanley Booth, Austin, TX (US)

(73) Assignee: Nuventix Inc.

(21) Appl. No.: 13/442,445

(22) Filed: Apr. 9, 2012

Related U.S. Application Data
(63) Continuation-in-part of application No. 13/332,923, filed on Dec. 21, 2011.
(60) Provisional application No. 61/425,385, filed on Dec. 21, 2010.
(60) Provisional application No. 61/486,985, filed on May 17, 2011.

(51) Int. Cl. B05B 1/08

(52) U.S. Cl. 239/102.1

(57) ABSTRACT

A synthetic jet ejector is provided which includes (a) a first actuator comprising a first diaphragm driven by a first actuator coil, wherein said first actuator coil is disposed on a first side of said first diaphragm; (b) a second actuator comprising a second diaphragm driven by a second actuator coil, wherein said second actuator coil is disposed on a first side of said second diaphragm; and (c) an airtight enclosure which encloses said first and second actuator coils; wherein at least one of said first and second diaphragms is in fluidic communication with the environment external to said enclosure.

### CROSS-REFERENCE TO RELATED APPLICATIONS

The present application is a continuation-in-part of, and claims priority to, U.S. Ser. No. 13/332,923 (Darbin et al.), entitled “Systems And Methodologies For Preventing Dust and Particle Contamination of Synthetic Jet Ejectors”, which was filed on Dec. 21, 2011, and which is incorporated herein by reference in its entirety, and which claims priority from U.S. Ser. No. 61/425,385 (Darbin et al.), entitled “Systems And Methodologies For Preventing Dust and Particle Contamination of Synthetic Jet Ejectors”, which was filed on Dec. 21, 2010, and which is incorporated herein by reference in its entirety. The present application also claims priority to U.S. Ser. No. 61/486,985 (Schwickert et al.), entitled “Synthetic Jet Ejector with Sealed Motor”, which was filed on May 17, 2011, and which is incorporated herein by reference in its entirety.

### FIELD OF THE DISCLOSURE

The present disclosure relates generally to synthetic jet ejectors, and more particularly to systems and methods for preventing dust and ambient particles from contaminating synthetic jet ejectors and the actuator assemblies thereof.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled “Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques.

Further advances have been made in the art of synthetic jet ejectors, both with respect to synthetic jet ejector technology in general and with respect to the applications of this technology. Some examples of these advances are described in U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; U.S. Pat. No. 7,819,556 (Heffington et al.), entitled “Thermal Management System for LED Array”; U.S. Pat. No. 7,932,535 (Mahalingam et al.), entitled “Synthetic Jet Cooling System for LED Module”; U.S. Pat. No. 8,030,886 (Mahalingam et al.), entitled “Thermal Management of Batteries Using Synthetic Jets”; U.S. Pat. No. 8,035,966 (Reichenbach et al.), entitled “Electronics Package for Synthetic Jet Ejectors”; U.S. Pat. No. 8,006,410 (Booth et al.), entitled “Light Fixture with Multiple LEDs and Synthetic Jet Thermal Management System”; U.S. Pat. No. 8,069,910 (Beltran et al.), entitled “Acoustic Resonator for Synthetic Jet Generation for Thermal Management”; and U.S. Pat. No. 8,136,576 (Grimm), entitled “Vibration Isolation System for Synthetic Jet Devices”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal Management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20070096118 (Mahalingam et al.), entitled “Synthetic Jet Cooling System for LED Module”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; and U.S. 20070141453 (Mahalingam et al.), entitled “Thermal Management of Batteries using Synthetic Jets”.

### BRIEF DESCRIPTION OF THE DRAWINGS

FIG. 1A is a schematic cross-sectional side view of a zero net mass flux synthetic jet actuator with a control system.

FIG. 1B is a schematic cross-sectional side view of the synthetic jet actuator of FIG. 1A depicting the jet as the control system causes the diaphragm to travel inward, toward the orifice.

FIG. 1C is a schematic cross-sectional side view of the synthetic jet actuator of FIG. 1A depicting the jet as the control system causes the diaphragm to travel outward, away from the orifice.

FIG. 2 depicts a particular, non-limiting embodiment of a synthetic jet ejector equipped with a barrier to prevent dust intake.

FIG. 3 depicts a particular, non-limiting embodiment of a synthetic jet ejector equipped with a barrier to prevent dust intake.

FIG. 4 depicts a particular, non-limiting embodiment of a synthetic jet ejector equipped with a motor portion isolated from the ambient environment to prevent dust intake.

FIG. 5 depicts a particular, non-limiting embodiment of a synthetic jet ejector equipped with a motor portion isolated from the ambient environment to prevent dust intake.

FIG. 6 depicts a particular, non-limiting embodiment of a synthetic jet ejector equipped with a motor portion isolated from the ambient environment to prevent dust intake.

FIG. 7 depicts a particular, non-limiting embodiment of a nozzle for a synthetic jet ejector, wherein the nozzle is equipped with electrostatic plates for preventing dust intake.

FIG. 8 depicts a particular, non-limiting embodiment of a synthetic jet ejector equipped with electrostatic wires for preventing dust intake.

FIG. 9 depicts a charge phase diagram for the operation of the synthetic jet ejector of FIG. 8.

FIG. 10 depicts a circuit diagram for a particular, non-limiting embodiment of a synthetic jet ejector equipped with electrostatic plates for preventing dust intake.

FIG. 11 depicts the operation of a particular, non-limiting embodiment of a synthetic jet ejector equipped with a sealed motor to prevent dust intake.

FIG. 12 depicts a particular, non-limiting embodiment of a synthetic jet ejector equipped with a sealed motor to prevent dust intake.

FIG. 13 depicts a particular, non-limiting embodiment of a synthetic jet ejector equipped with a sealed motor to prevent dust intake.

FIG. 14 is an illustration of stand-alone diaphragm which may be utilized to seal a synthetic jet actuator from the ambient environment.

FIG. 15 depicts a particular, non-limiting embodiment of a synthetic jet ejector equipped with a sealed motor configuration.

FIG. 16 depicts a particular, non-limiting embodiment of a synthetic jet ejector equipped with a sealed motor configuration.

FIG. 17 depicts a particular, non-limiting embodiment of a synthetic jet ejector equipped with a sealed motor configuration.

### SUMMARY OF THE DISCLOSURE

In one aspect, a synthetic jet ejector is provided which comprises (a) a first actuator comprising a first diaphragm driven by a first actuator coil, wherein said first actuator coil is disposed on a first side of said first diaphragm; (b) a second actuator comprising a second diaphragm driven by a second actuator coil, wherein said second actuator coil is disposed on a first side of said second diaphragm; and (c) an airtight enclosure which encloses said first and second actuator coils; wherein at least one of said first and second diaphragms is in fluidic communication with the environment external to said enclosure. A method is also provided for operating the foregoing synthetic jet ejector, wherein said first and third actuator coils are operated out-of-phase.

In another aspect, a synthetic jet ejector is provided which comprises (a) a first diaphragm driven by a first actuator; and (b) a second diaphragm driven by a second actuator; wherein said first and second actuators are disposed within a hermetically sealed compartment.

In a further aspect, a synthetic jet ejector is provided which comprises (a) a first actuator which contains first and second voice coils and which is disposed in a hermetically sealed compartment; (b) a second actuator which contains third and fourth voice coils, and which is disposed in said hermetically sealed compartment; (c) first and second diaphragms which are driven by said first actuator and which are in fluidic communication with the ambient environment by way of respective first and second sets of orifices; and (d) third and fourth diaphragms which are driven by said second actuator and which are in fluidic communication with the ambient environment by way of respective third and fourth sets of orifices.

In a further aspect, a synthetic jet ejector is provided which comprises (a) a diaphragm having a magnet attached thereto; and (b) a drive coil which vibrates said diaphragm by producing an oscillating magnetic field that alternately attracts and repels said magnet.

In another aspect, a synthetic jet ejector is disclosed which comprises a housing having an orifice defined in a wall thereof from which a synthetic jet is emitted, and a barrier disposed about said orifice. The barrier has a first end (disposed proximal to said orifice) which has a first perimeter, and a second end (disposed distal to said orifice) which has a second perimeter. The second perimeter has a larger circumference than said first perimeter.

In another aspect, a synthetic jet ejector is disclosed which comprises (a) a housing; (b) a synthetic jet actuator disposed within said housing and comprising a diaphragm, a magnet and a pot, wherein said magnet and pot are disposed on a first side of said diaphragm; and (c) a porous member disposed within said housing on said first side of said diaphragm.

In another aspect, a synthetic jet ejector is disclosed which comprises a housing having a first compartment with a first diaphragm disposed therein and a second compartment with a second diaphragm disposed therein. The first diaphragm separates said first compartment into first and second sub-compartments, and the second diaphragm separates said second compartment into third and fourth sub-compartments. The second and fourth sub-compartments are in fluidic communication with each other by way of a conduit. The first sub-compartment has a first aperture in fluidic communication therewith from which a first synthetic jet is ejected, and the third sub-compartment has a second aperture in fluidic communication therewith from which a second synthetic jet is ejected.

In a further aspect, a synthetic jet ejector is disclosed which comprises (a) a housing equipped with first and second apertures; (b) first, second, third and fourth diaphragms, disposed within said housing, which divide the interior space of said housing into first, second, third, fourth and fifth compartments, wherein said second compartment is disposed between, and in fluidic communication with, said first and second diaphragms and is further in fluidic communication with said first aperture, and wherein said fourth compartment is disposed between, and in fluidic communication with, said third and fourth diaphragms and is further in fluidic communication with said second aperture; and (c) a conduit in fluidic communication with said first and fifth compartments.

In still another aspect, a synthetic jet ejector is disclosed which comprises (a) a first actuator comprising a first diaphragm driven by a first coil, wherein said first coil is disposed on a first side of said first diaphragm; (b) a second actuator comprising a second diaphragm driven by a second coil, wherein said second coil is disposed on a first side of said second diaphragm; and (c) an airtight enclosure which encloses said first and second coils; wherein at least one of said first and second diaphragms is in fluidic communication with the ambient environment.

In yet another aspect, a synthetic jet ejector is disclosed which comprises (a) a synthetic jet actuator comprising a first housing equipped with a first aperture and having a first diaphragm disposed therein; (b) a second housing equipped with an inlet and an outlet and having first and second compartments therein which are separated from each other by a second diaphragm, wherein said first compartment is in fluidic communication with said inlet, and wherein said second compartment is in fluidic communication with said outlet; and (c) a first conduit releasably attached to said first housing which fluidically connects said first aperture to said inlet.

In a further aspect, a synthetic jet ejector is disclosed which is equipped with an electrostatic dust guard. The synthetic jet ejector comprises (a) a synthetic jet actuator comprising a housing equipped with an aperture and having a diaphragm disposed therein; and (b) an electrical circuit equipped with a power source, a switch and an electrical conduit, wherein said switch transforms said electrical conduit between a first state and a second state, wherein said electrical conduit is disposed in the vicinity of said aperture, and wherein either (i) the electrical conduit is in a charged state when it is in the first state, and is in an uncharged state when it is in the second state, or (ii) the electrical conduit is in a charged state having a first polarity when it is in the first state, and is in a charged state having the opposite polarity when it is in the second state.

### DETAILED DESCRIPTION

Prior to describing the devices and methodologies described herein, a brief explanation of a typical synthetic jet ejector, and the manner in which it operates to create a synthetic jet, may be useful.

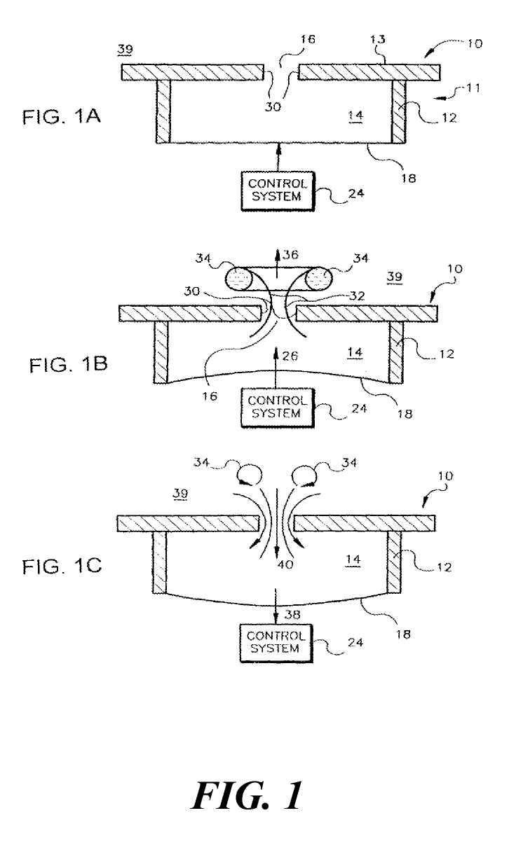

The formation of a synthetic jet may be appreciated with respect to FIGS. 1A-1C. FIG. 1A depicts a synthetic jet actuator 10 comprising a housing 11 defining and enclosing an internal chamber 14. The housing 11 and chamber 14 can take virtually any geometric configuration, but for purposes of discussion and understanding, the housing 11 is shown in cross-section in FIG. 1A to have a rigid side wall 12, a rigid front wall 13, and a rear diaphragm 18 that is flexible to an extent to permit movement of the diaphragm 18 inwardly and outwardly relative to the chamber 14. The front wall 13 has an orifice 16 of any geometric shape. The orifice 16 diametrically opposes the rear diaphragm 18 and connects the internal chamber 14 to an external environment having ambient fluid 39.

The flexible diaphragm 18 may be controlled to move by any suitable control system 24. For example, the diaphragm 18 may be equipped with a metal layer, and a metal electrode may be disposed adjacent to but spaced from the metal layer so that the diaphragm 18 can be moved via an electrical bias imposed between the electrode and the metal layer. Moreover, the generation of the electrical bias can be controlled by any suitable device, for example but not limited to, a computer, logic processor, or signal generator. The control system 24 can cause the diaphragm 18 to move periodically, or modulate in time-harmonic motion, and force fluid in and out of the orifice 16.

Alternatively, a piezoelectric actuator could be attached to the diaphragm 18. The control system would, in that case, cause the piezoelectric actuator to vibrate and thereby move the diaphragm 18 in time-harmonic motion. The method of causing the diaphragm 18 to modulate is not particularly limited to any particular means or structure.

The operation of the synthetic jet actuator 10 will now be described with reference to FIGS. 1B and 1C. FIG. 1B depicts the synthetic jet actuator 10 as the diaphragm 18 is controlled to move inward into the chamber 14, as depicted by arrow 26. The chamber 14 has its volume decreased and fluid is ejected through the orifice 16. As the fluid exits the chamber 14 through the orifice 16, the flow separates at sharp orifice edges 30 and creates vortex sheets 32 which roll into vortices 34 and begin to move away from the orifice edges 30 in the direction indicated by arrow 36.

FIG. 1C depicts the synthetic jet actuator 10 as the diaphragm 18 is controlled to move outward with respect to the chamber 14, as depicted by arrow 38. The chamber 14 has its volume increased and ambient fluid 39 rushes into the chamber 14 as depicted by the set of arrows 40. The diaphragm 18 is controlled by the control system 24 so that when the diaphragm 18 moves away from the chamber 14, the vortices 34 are already removed from the orifice edges 30 and thus are not affected by the ambient fluid 39 being drawn into the chamber 14. Meanwhile, a jet of ambient fluid 39 is synthesized by the vortices 34 creating strong entrainment of ambient fluid drawn from large distances away from the orifice 16.

Synthetic jet ejectors represent a considerable advance in the art. This is especially true in thermal management applications, where they are frequently utilized, alone or in conjunction with a fan-based thermal management system, to provide quiet, energy efficient and localized cooling for LEDs, CPUs and other heat sources. Nonetheless, further improvement is required in these devices. In particular, it has been found that the performance of synthetic jet ejectors can degrade over time.

It has now been found that the presence of dust or particulate contaminants in the ambient environment is a significant cause of performance degradation in synthetic jet ejectors. It has further been found that this effect may be mitigated by sealing off the motor of the synthetic jet ejector from the ambient environment, or by providing a dust barrier (which may be physical or electrostatic) between the motor and the ambient environment.

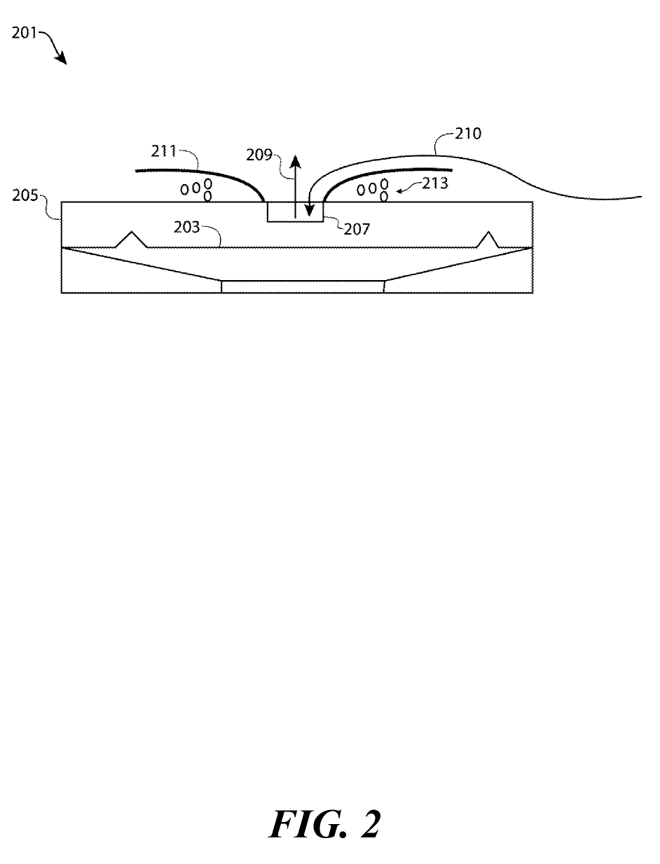

FIG. 2 depicts a particular, non-limiting embodiment of a synthetic jet ejector 201 in accordance with the teachings herein. The synthetic jet ejector 201 in this embodiment comprises a diaphragm 203 disposed within a housing 205. The housing 205 is equipped with an aperture 207 from which a synthetic jet 209 is emitted (here, it is to be noted that, in the various embodiments described herein, apertures or orifices may also take the form of nozzles). Of course, it will be appreciated that, while only a single aperture 207 and a single synthetic jet 209 are depicted in FIG. 2 for purposes of simplicity, an actual device made in accordance with this embodiment may feature a plurality of nozzles or apertures, and may emit one or more synthetic jets.

Still referring to FIG. 2, the synthetic jet ejector 201 is equipped with one or more barriers 211 or deflectors disposed about the aperture 207. The barrier 211 is designed to trap dust or other particulate contaminants 213 before they can enter the aperture 207. The specific shape, construction and configuration of the barrier 211 may vary from one embodiment to another and may depend, for example, on the typical particle sizes of the contaminants that the barrier 211 is designed to block, the disposition of the nozzles or apertures, the frequencies at which the synthetic jet ejector is designed to operate, and other such considerations.

For example, the barrier 211 could comprise one or more solid barriers, or may comprise various screens, meshes, fibers, or other porous materials. Also, in some embodiments, the barrier 211 may comprise multiple sections. For example, in some embodiments, the barrier 211 may comprise overlapping sheaths which are arranged like the petals of a flower. Moreover, each of these barriers 211 or screens may have a variety of shapes.

The barrier 211 may be frustoconical in shape, or may be concave or convex. Preferably, however, the barrier 211 has a first end having a first perimeter which is disposed proximal to the orifice 207, and a second end having a second perimeter which is distal to the orifice 207, and the second perimeter is preferably larger than the first perimeter. It is also preferred that the first end forms a fluidic seal with the housing 205 and is centered on the orifice 207, and that the second end is open to the ambient environment. It is further preferred that the barrier 211 curves outward in the direction going from the first end to the second end.

In some embodiments, the barrier 211 may have a major surface described by the rotation of a curve about an axis. The barrier 211 may also have a rotational axis of symmetry about the center of the orifice 207, and preferably, any plane which bisects the rotational axis of symmetry also bisects the barrier 211. In some embodiments, the barrier 211 may have a cross-sectional shape, in a plane parallel to the wall of the housing in which the orifice 207 is disposed, which is circular or elliptical.

As described above with reference to FIGS. 1B and 1C, during the suction phase of a synthetic jet ejector, the flow entrainment associated with the formation of a synthetic jet 209 occurs primarily along an axis parallel to the plane of the aperture 207. Hence, the provision of the aforementioned barrier 211 in this area serves to effectively trap particulate contaminants before they can enter the aperture 207 as, for example, by redirecting the flow of fluid along the surface of the housing 205.

It will, of course, be appreciated that a similar approach may be utilized if the aperture is in the form of a nozzle. In such an embodiment, the barrier 211 may extend from the body or the tip of the nozzle, or the nozzle may extend from the barrier 211. For example, in one implementation of the latter embodiment, the nozzle may extend from the barrier 211 in a manner analogous to the way a stamen extends from a flower.

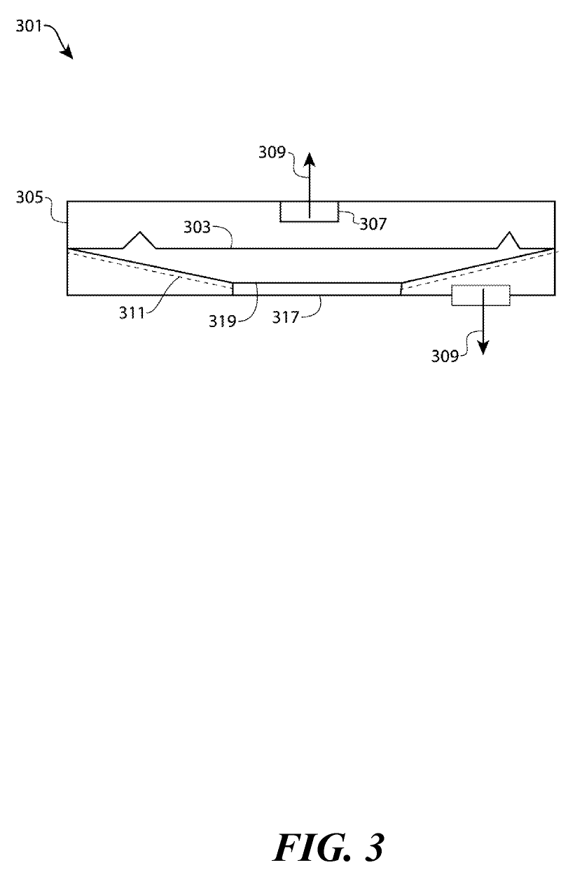

FIG. 3 depicts another particular, non-limiting embodiment of a synthetic jet ejector 301 in accordance with the teachings herein. The synthetic jet ejector 301 in this embodiment is similar in many respects to the embodiment of FIG. 2, and comprises a diaphragm 303 disposed within a housing 305. The housing 305 is equipped with an aperture 307 (which may also take the form of a nozzle) on each major surface of the housing from which a synthetic jet 309 is emitted. Of course, it will be appreciated that, while only a single aperture 307 and a single synthetic jet 309 are depicted on each major surface of the housing for purposes of simplicity, an actual device made in accordance with this embodiment may feature one or more nozzles or apertures on one or more major surfaces, and may emit one or more synthetic jets.

The synthetic jet ejector 301 in this embodiment is equipped with a screen 311 or other barrier which is disposed on a side of the synthetic jet ejector 301 exposed to the ambient environment. The screen 311 is of appropriate mesh and construction to capture particles of dust and other contaminants. Since the screen 311 is placed in a region that is not exposed to high velocities, the pressure drop will not be as high as if the screen 311 is disposed at the aperture 307. This embodiment is particularly suitable for preventing the accumulation of dust and other contaminants on the magnet 317 and pot 319 of the synthetic jet ejector 301.

Various types of screening, mesh or other porous materials may be utilized in this embodiment or in the other embodiments disclosed herein (including, for example, any of the porous materials in the previously described embodiment). For example, such screening or mesh 311 may be metallic or polymeric, or may comprise a rigid or conformable fabric. Preferably, the synthetic jet ejector 301 operates to create a fluidic flow between the diaphragm and an aperture in the housing such that the fluidic flow passes through the screen 311 and creates a synthetic jet 309 at the aperture 307 or nozzle.

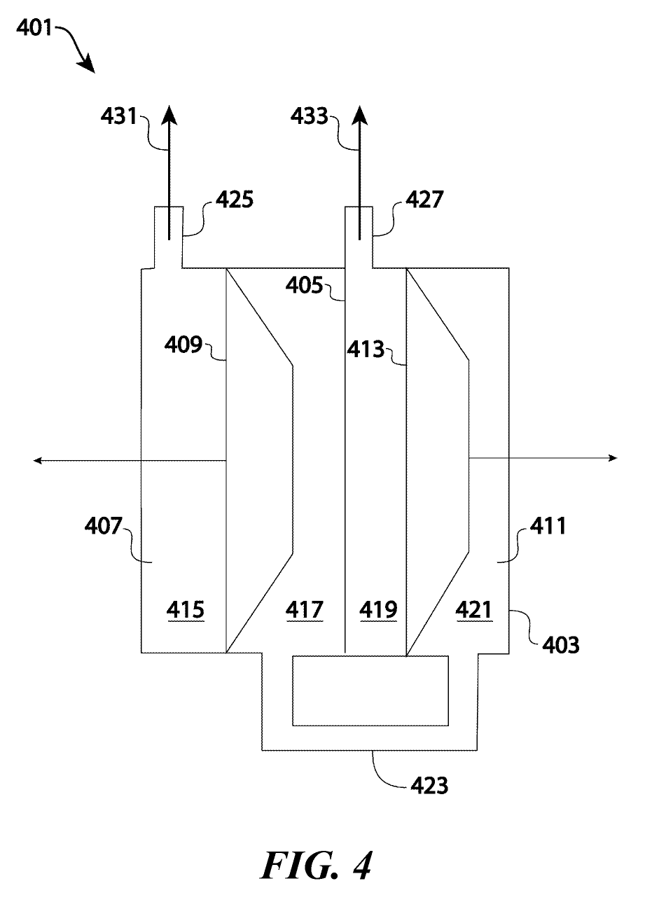

FIG. 4 depicts another particular, non-limiting embodiment of a synthetic jet ejector 401 in accordance with the teachings herein. The synthetic jet ejector 401 in this embodiment is equipped with a housing 403 having a partition 405 therein which divides the interior of the housing 403 into a first compartment 407 having a first diaphragm 409 disposed therein, and a second compartment 411 having a second diaphragm 413 disposed therein.

The first diaphragm 409 further divides the first compartment 407 into first 415 and second 417 sub-compartments. Similarly, the second diaphragm 413 further divides the second compartment 411 into third 419 and fourth 421 sub-compartments. A conduit 423 connects the second 417 and fourth 421 sub-compartments. The housing 403 is also equipped with first 425 and second 427 nozzles (which, in alternative embodiments, may be apertures), and the first 415 and third 419 sub-compartments are in fluidic communication with the first 425 and second 427 nozzles, respectively.

In operation, the first 409 and second 413 diaphragms are preferably operated out-of-phase, and more preferably 180° out-of-phase. Because the second 417 and fourth 421 sub-compartments are in fluidic communication with each other, these compartments may be hermetically sealed from the external environment, while still allowing the first 409 and second 413 diaphragms to vibrate as required to form synthetic jets 431 and 433 at nozzles 425 and 427, respectively. Advantageously, because the second 417 and fourth 421 sub-compartments are hermetically sealed from the external environment and house the magnets and pots that drive the diaphragms 409 and 413, these elements are protected from any dust or debris present in the external environment.

While the conduit 423 is depicted as being tubular, it will be appreciated that conduits of various geometries and dimensions may be utilized in embodiments of this type. It will further be appreciated that, in some implementations, multiple conduits 423 may be utilized. Moreover, the conduit 423 may be equipped with one or more heat fins on an interior or exterior surface thereof.

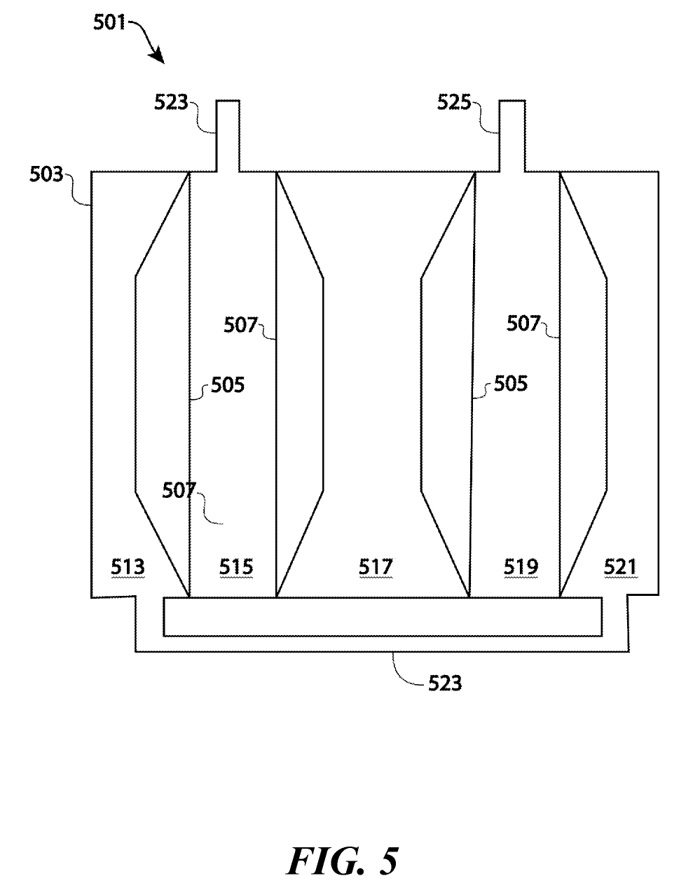

FIG. 5 depicts another particular, non-limiting embodiment of a synthetic jet ejector 501 in accordance with the teachings herein. The synthetic jet ejector 501 in this embodiment is similar in some respects to the embodiment of FIG. 4. In this embodiment, the synthetic jet ejector 501 comprises a housing 503 having first 505, second 507, third 509 and fourth 511 diaphragms disposed therein which divide the interior of the housing 503 into first 513, second 515, third 517, fourth 519 and fifth 521 compartments. The housing is equipped with first 523 and second 525 nozzles (in some variations of these embodiments, one or both of nozzles 523, 525 may be apertures) which are in fluidic communication with the second 515 and fourth 519 compartments.

Notably, the second compartment 515 is bounded by the first 505 and second 507 diaphragms, and the fourth 519 compartment is bounded by the third 509 and fourth 511 diaphragms. Also, the first 513 and fifth 521 compartments are in fluidic communication with each other by way of a conduit 523.

In operation, the first 505 and second 507 diaphragms are preferably operated out-of-phase, and more preferably 180° out-of-phase, and the third 509 and fourth 511 diaphragms are preferably operated out-of-phase, and more preferably 180° out-of-phase. Even more preferably, both sets of diaphragms are operated out of phase, and most preferably, both sets of diaphragms are operated 180° out of phase. Because the first 513 and fifth 521 compartments are in fluidic communication with each other, these compartments may be hermetically sealed from the external environment, while still allowing the first 505 and fourth 511 diaphragms to vibrate. Similarly, the third compartment may be hermetically sealed from the external environment, while still allowing the second 507 and third 509 diaphragms to vibrate, by oscillating the second 507 and third 509 diaphragms out-of-phase.

Advantageously, because the first 513, third 517 and fifth 521 compartments are hermetically sealed from the external environment and house the magnets and pots that drive the diaphragms, these elements are protected from any dust, debris, salt, acid, or other contaminants present in the external environment. Moreover, the presence of the conduit 523 prevents the formation of an air spring in the sealed motor cavities. Here, it is to be noted that the presence of an air spring may alter the resonance of the synthetic jet ejector 501.

While the conduit 523 is depicted as being tubular, it will be appreciated that conduits of various geometries and dimensions may be utilized in embodiments of this type. It will further be appreciated that, in some implementations, multiple conduits 523 may be utilized. Moreover, the conduit 523 may be equipped with one or more heat fins on an interior or exterior surface thereof.

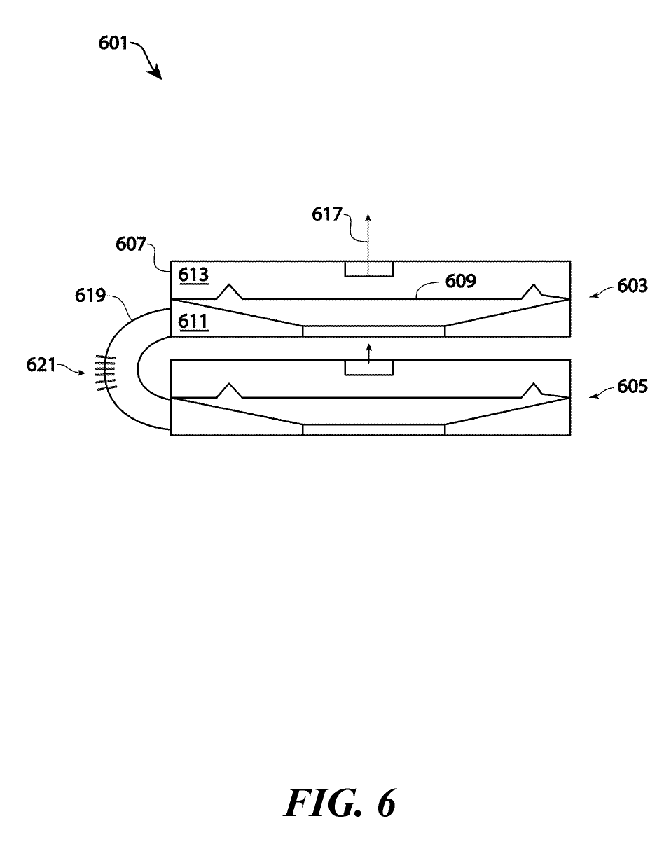

FIG. 6 depicts another particular, non-limiting embodiment of a synthetic jet ejector 601 in accordance with the teachings herein. The synthetic jet ejector 601 in this embodiment comprises first 603 and second 605 synthetic jet actuators which are mounted on top of each other. Each of the first 603 and second 605 synthetic jet actuators comprises a housing 607 having a diaphragm 609 disposed therein which separates the housing 607 into first 611 and second 613 distinct compartments which are sealed off from each other. Each of the second compartments 613 is equipped with one or more apertures 615 from which one or more synthetic jets 617 are emitted.

Each of the first 611 compartments contains the coil and other components of the actuator that cause the diaphragm 607 to vibrate. The first compartments 611 are sealed off from the ambient environment, but are in fluidic communication with each other by way of a conduit 619. In addition to reducing or eliminating pressure differences between the first compartments 607, the conduit 619 may also serve to dissipate heat to the ambient environment.

While the conduit 619 is depicted as being tubular, it will be appreciated that conduits of various geometries and dimensions may be utilized in embodiments of this type. It will further be appreciated that, in some implementations, multiple conduits 619 may be utilized. Moreover, the conduit 619 may be equipped with one or more heat fins on an interior or exterior surface thereof to aid in heat dissipation to the ambient environment.

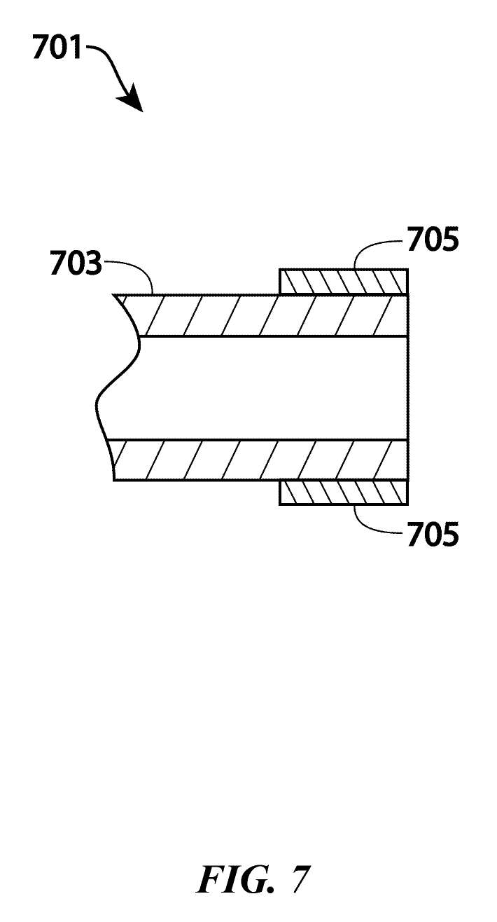

FIG. 7 depicts a particular, non-limiting embodiment of a nozzle 701 for a synthetic jet ejector in accordance with the teachings herein. The nozzle 701 is depicted in a cross-sectional view taken in a plane which contains the longitudinal axis of the nozzle. The nozzle 701 is preferably circular or elliptical in a cross-section taken perpendicular to its longitudinal axis, and comprises a wall 703 having charge plates 705 disposed on an exterior surface thereof.

A nozzle of this type may be incorporated into a wide variety of synthetic jet ejectors to keep dust and other particulate contaminants from entering the synthetic jet ejector during the inflow phase of operation (this phase is illustrated in FIG. 1c). For example, the charge on the charge plates 705 may be oscillated in concert with the inflow and outflow cycles of the synthetic jet ejector. Preferably, the charge plates 705 are given a positive charge during the inflow cycle of the synthetic jet ejector, and are given a negative (or zero) charge during the outflow cycle of the synthetic jet ejector. In this way, dust (which is typically negatively charged) may be trapped on the charge plates 705 during the inflow cycle, and then dispersed to the ambient environment during the outflow cycle. Due to the highly directional and turbulent nature of synthetic jets, this may have the effect of dispersing dust a considerably distance away from the synthetic jet ejector, where it is less likely to be drawn into the synthetic jet ejector during future cycles.

In some embodiments, an opposite strategy may be utilized. In particular, in some embodiments, a negative charge may be applied to the charge plates 705 during the inflow cycle of the synthetic jet ejector, and a positive (or zero) charge may be applied to the charge plates 705 during the outflow cycle. This may have the effect of repelling dust from the vicinity of the aperture during the inflow cycle.

In still other embodiments, a positive or negative charge may be applied to the charge plates 705 during both the inflow and outflow cycles (for example, a constant charge may be utilized). For example, a constant negative charge may be utilized to provide a constant repulsive charge for dust particles in the vicinity of the aperture while the synthetic jet ejector is in operation. Alternatively, a constant positive charge may be utilized to attract dust to the charge plates 705; in such an embodiment, the greater turbulence and directionality associated with the formation of a synthetic jet during the outflow cycle may be utilized to overcome the attractive charge, thus dislodging dust from the charge plates 705. Of course, it will be appreciated that various parameters may affect the operation of these embodiments including, but not limited to, the geometry and dimensions of the aperture, the dimensions and position of the plates, and the magnitude of the charge.

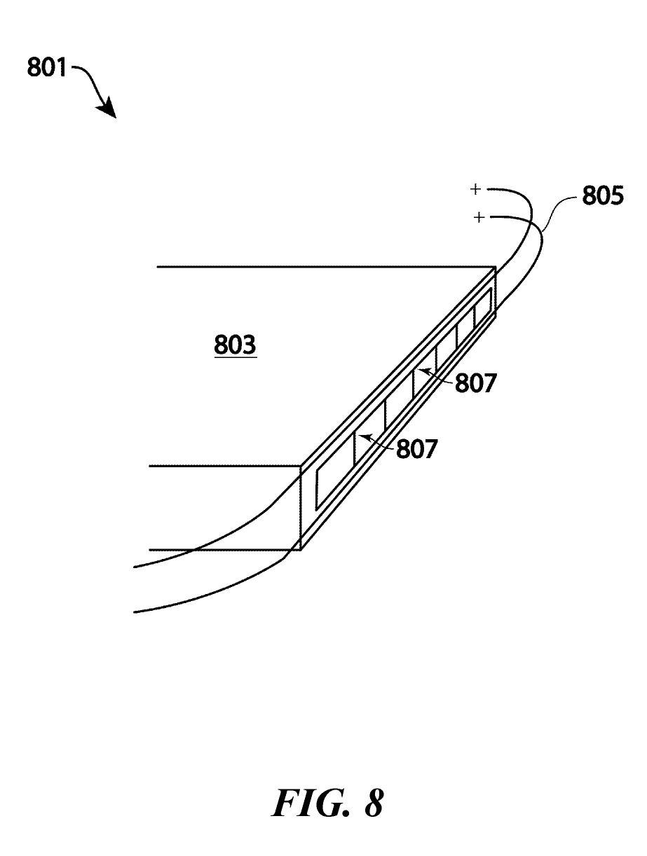

FIG. 8 depicts a particular, non-limiting embodiment of a synthetic jet ejector in accordance with the teachings herein. The synthetic jet ejector 801 in this embodiment comprises a synthetic jet actuator 803 which is equipped with a dust trap 805 in the form of an electrically conductive element such as, for example, a wire, mesh, grid, or metal plates. The dust trap 805 is placed in front of the jet orifices 807 of the synthetic jet actuator 803.

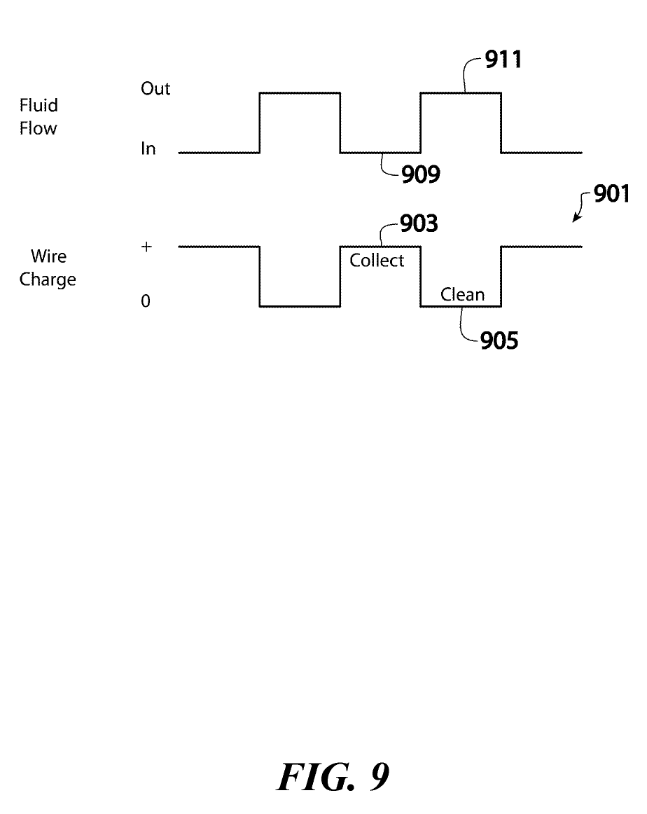

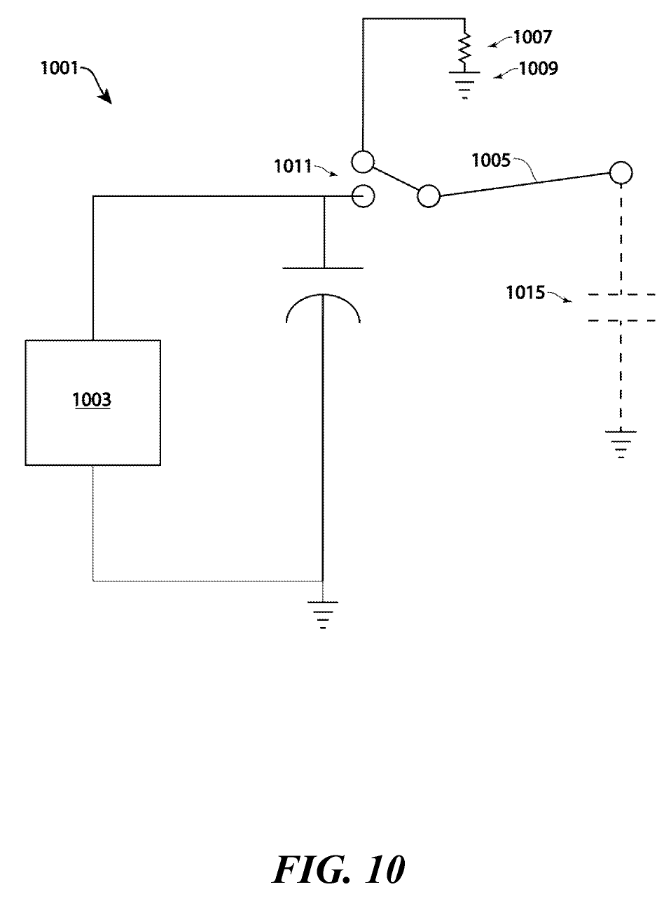

The operation of the synthetic jet ejector 801 of FIG. 8 is depicted in FIG. 9. As seen therein, the input and output voltages are oscillated, preferably in a manner that describes a step function or saw tooth wave function 901, between a first state 903 and a second state 905. In the first state 903, the voltage is preferably positive and preferably causes the dust trap 805 (see FIG. 10) to collect dust (which typically has a negative charge), thus preventing it from entering the jet orifices 807 of the synthetic jet actuator 803. In the second state 905, the voltage is preferably zero or negative, and preferably repels the dust that has been collected during the first state. Of course, it will be appreciated that the various modifications described with respect to the embodiment of FIG. 7 may apply here as well.

Preferably, the dust trap 805 is operated with the same periodicity as the synthetic jet actuator 803 such that dust is collected on the dust trap 805 during the inflow stage 809 of the synthetic jet actuator 803, and is repelled during the outflow stage 911. Since the jet exhaust is much stronger than the intake suction, this mode of operation causes any dust which is trapped on the dust trap 805 to be blown a significant distance away from the dust trap 805 when it is released. Hence, the dust and contaminants do not become re-attracted to the dust trap 805, thus avoiding the creation of dust balls.

FIG. 10 illustrates a particular, non-limiting embodiment of a circuit design which may be utilized to operate the dust trap 805 of FIG. 8. The circuit design 1001 includes a power source 1003, a conductive element 1005 (corresponding, for example, to wire 805 of FIG. 8) equipped with a resistor 1007 and ground 1009, and a switch 1011 which controls the charge on the conductive element 1005. Stray capacitance 1013 on the conductive element 1005 is indicated in the circuit element 1015 depicted with dashed lines.

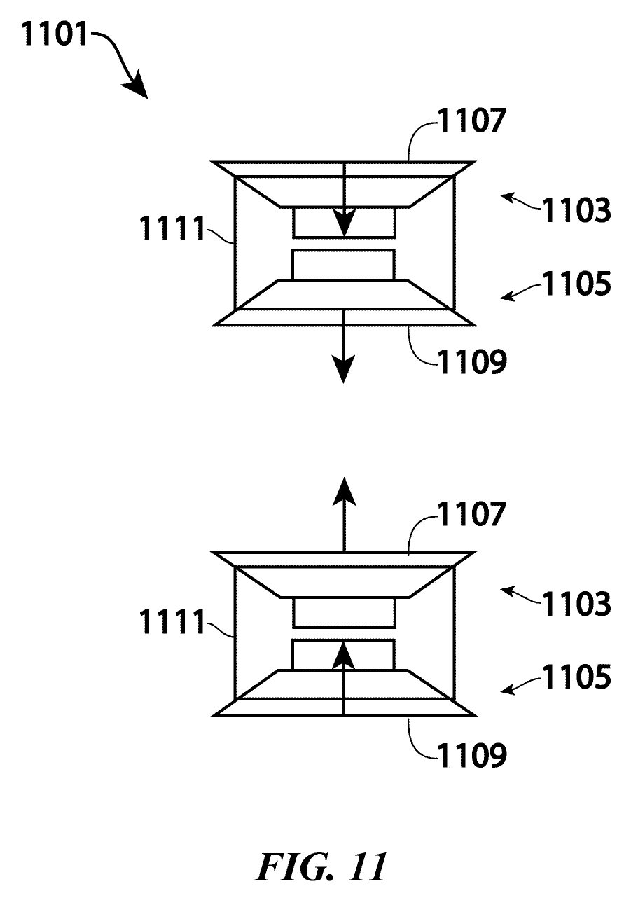

FIG. 11 illustrates another particular, non-limiting embodiment of a synthetic jet ejector in accordance with the teachings herein, shown at different phases during its operation. The synthetic jet ejector 1101 depicted therein comprises first 1103 and second 1105 actuators mounted in a back-to-back arrangement such that their first 1107 and second 1109 respective diaphragms are facing away from each other. The space between the first 1107 and second 1109 diaphragms is disposed within an enclosure 1111. The enclosure 1111 preferably provides an airtight seal, but in some embodiments may comprise any of the porous materials noted with respect to the previous embodiments.

The motion of the actuators is indicated by the arrows. Preferably, the actuators are operated out of phase so that both are moving in the same direction, thus avoiding the creation of pressure differences within the enclosure 1111.

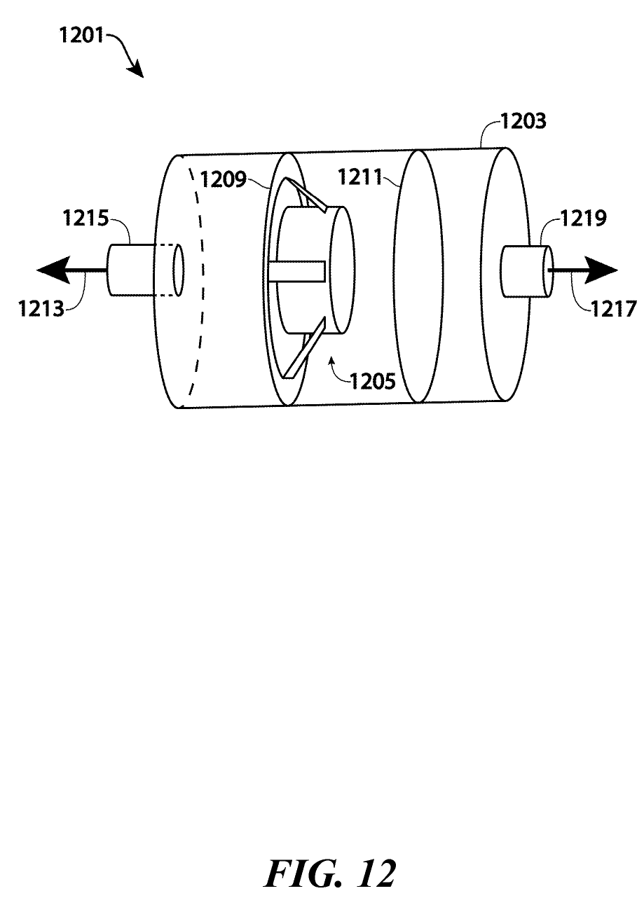

FIG. 12 depicts another particular, non-limiting embodiment of a synthetic jet ejector in accordance with the teachings herein. The synthetic jet ejector 1201 in this embodiment comprises a housing 1203 having a synthetic jet actuator 1205 disposed therein. The housing 1203 in the particular embodiment depicted is cylindrical, though one skilled in the art will appreciate that it may take various other shapes as well.

The synthetic jet actuator 1205 comprises an actuator 1207 and a first diaphragm 1209. The actuator 1207 is adapted to oscillate the first diaphragm 1209. A second or “slave” diaphragm 1211 is also disposed within the housing 1203 and is in fluidic communication with the first diaphragm 1209.

In operation, the actuator 1207 oscillates the first diaphragm 1209. Because the first diaphragm is in fluidic communication with the second diaphragm 1211 and the space between the two diaphragms is sealed, the oscillations in the first diaphragm 1209 cause corresponding oscillations in the second diaphragm 1211. As a result, a first synthetic jet 1213 is emitted from a first nozzle 1215 disposed on a first end of the housing 1203 through the action of the first diaphragm 1209, and a second synthetic jet 1217 is emitted from a second nozzle 1219 disposed on a first end of the housing 1203 through the action of the second diaphragm 1211. Of course, it will be appreciated that either or both of the first diaphragm 1209 and the second diaphragm 1211 may cause the formation of a plurality of synthetic jets at one or more nozzles or orifices. The first 1209 and second 1211 diaphragms may be the same or different, but preferably comprise the same material and have the same dimensions.

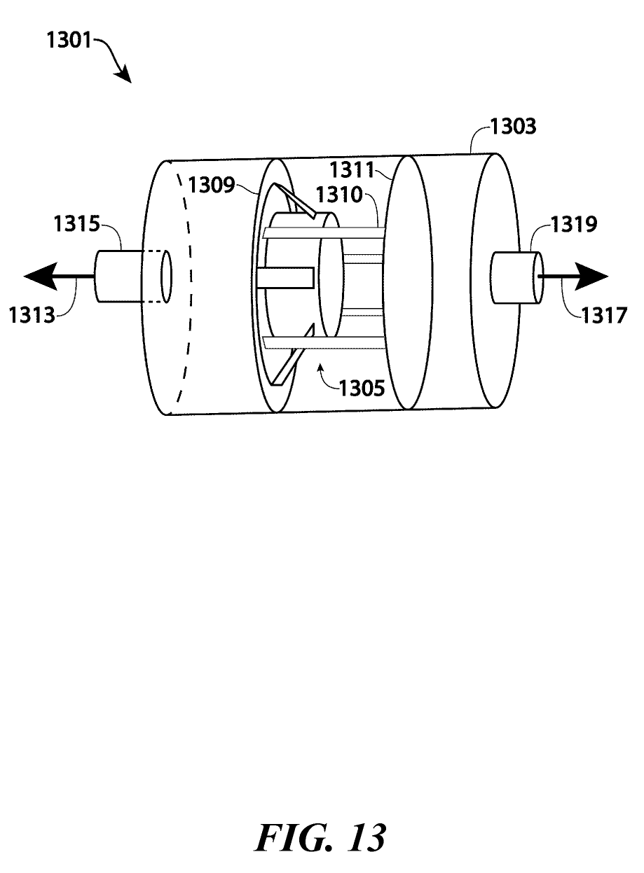

FIG. 13 depicts another particular, non-limiting embodiment of a synthetic jet ejector in accordance with the teachings herein which is similar in many respects to the synthetic jet ejector of FIG. 12, but which uses mechanical coupling, rather than fluidic coupling, to coordinate the motion of the first and second diaphragms. The synthetic jet ejector 1301 in this embodiment comprises a housing 1303 having a synthetic jet actuator 1305 disposed therein. As with the previous embodiment, the housing 1303 in the particular embodiment depicted is cylindrical, though one skilled in the art will appreciate that it may take various other shapes as well.

The synthetic jet actuator 1305 comprises an actuator 1307 and a first diaphragm 1309. The actuator 1307 is adapted to oscillate the first diaphragm 1309. A second or “slave” diaphragm 1311 is also disposed within the housing 1303 and is in mechanical communication with the first diaphragm 1309 by way of a plurality of struts 1310 or other connectors.

In operation, the actuator 1307 oscillates the first diaphragm 1309. Because the first diaphragm is in mechanical communication with the second diaphragm 1311, the oscillations in the first diaphragm 1309 cause corresponding oscillations in the second diaphragm 1311. As a result, a first synthetic jet 1313 is emitted from a first nozzle 1315 disposed on a first end of the housing 1303 through the action of the first diaphragm 1309, and a second synthetic jet 1317 is emitted from a second nozzle 1319 disposed on a first end of the housing 1303 through the action of the second diaphragm 1311.

Of course, it will be appreciated that either or both of the first diaphragm 1309 and the second diaphragm 1311 may cause the formation of a plurality of synthetic jets at one or more nozzles or orifices. Moreover, the first 1209 and second 1211 diaphragms may be the same or different, but preferably comprise the same material and have the same dimensions.

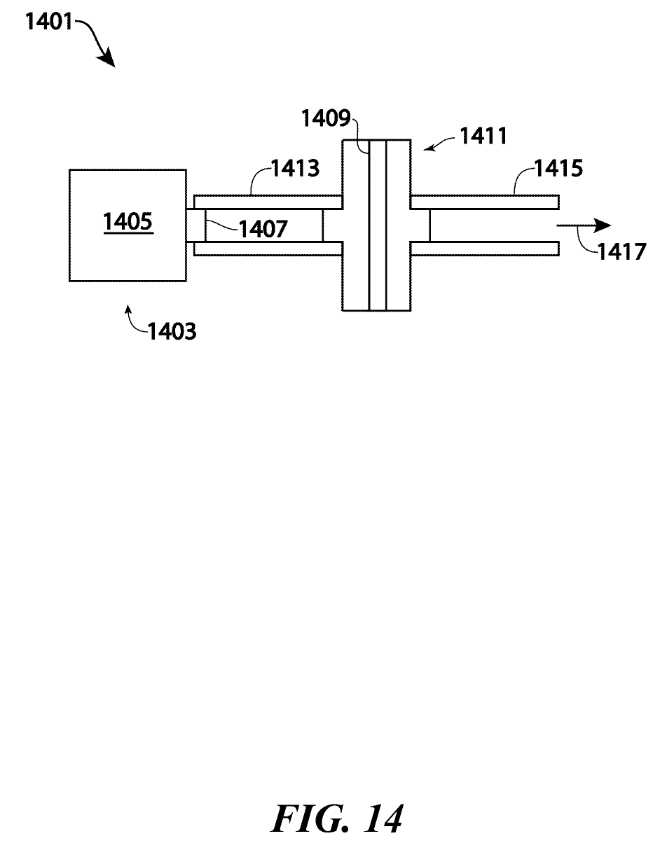

FIG. 14 illustrates another particular, non-limiting embodiment of a synthetic jet ejector in accordance with the teachings herein. In the embodiment depicted, the synthetic jet ejector 1401 comprises a synthetic jet actuator 1403 which includes a chamber 1405 and a nozzle 1407, and which is in fluidic communication with a bladder 1409 by way of a conduit 1411. The conduit 1411 in the illustrated embodiment has an inlet 1413 and an outlet 1415 which are separated from each other by the bladder 1409. Preferably, the conduit is releasably attachable to the nozzle 1407.

In operation, the synthetic jet ejector creates a fluidic flow into and out of the inlet 1413 of the conduit 1411, which causes the bladder 1409 to oscillate. The oscillation of the bladder 1409 causes the formation of a synthetic jet 1417 at the outlet 1415 of the conduit 1411.

The embodiment of FIG. 14 is advantageous in that the synthetic jet actuator 1503 and its components may be completely isolated from the external environment, and hence are not susceptible to damage by dust, salt, acid, or other environmental contaminants. Moreover, the conduit 1411 may be manufactured as a relatively inexpensive component which can be readily replaced if it is damaged or begins to malfunction, or if it is desired to change the operating characteristics of the synthetic jet ejector such as, for example, its resonance frequency or nozzle configuration (here, it is to be noted that the outlet 1415 of the conduit 1411 may be configured with one or more nozzles or apertures to create a desired distribution of synthetic jets or fluidic flow).

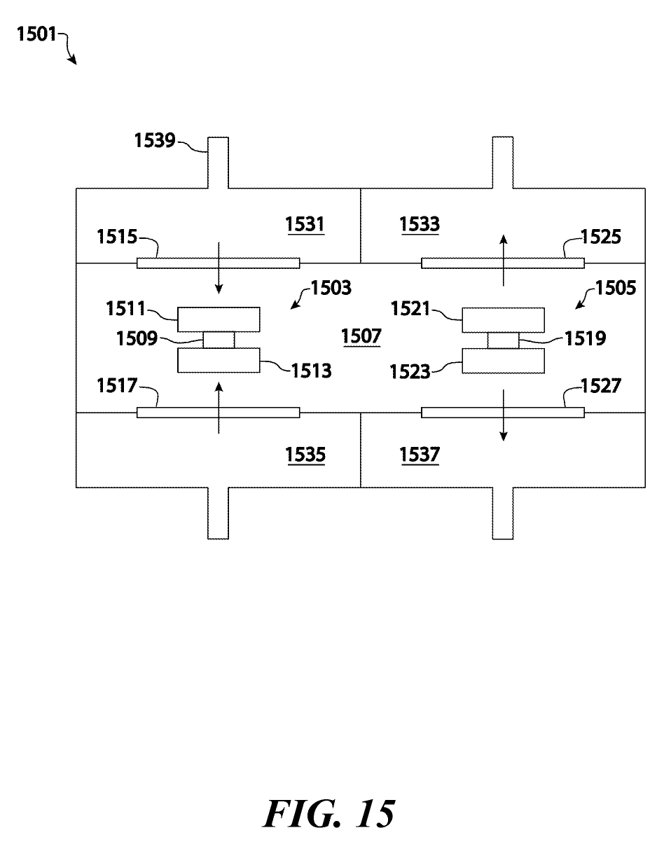

FIG. 15 illustrates another particular, non-limiting embodiment of a synthetic jet ejector in accordance with the teachings herein. In the embodiment depicted, the synthetic jet ejector 1501 comprises first 1503 and second 1505 synthetic jet actuators which are disposed in a central, hermetically sealed compartment 1507. The first synthetic jet actuator 1503 comprises a first permanent magnet 1509 which is disposed between first 1511 and second 1513 actuator coils (or voice coils), which respectively drive first 1515 and second 1517 diaphragms (e.g., by causing them to oscillate) in the manner required so as to form a synthetic jet. Similarly, the second synthetic jet actuator 1505 comprises a second permanent magnet 1519 which is disposed between third 1521 and fourth 1523 actuator coils (or voice coils), which respectively drive third 1525 and fourth 1527 diaphragms (e.g., by causing them to oscillate) in the manner required so as to form a synthetic jet.

The synthetic jet ejector 1501 further comprises first 1531, second 1533, third 1535 and fourth 1537 auxiliary compartments which are disposed adjacent to the central compartment 1507, and which are equipped with one or more apertures or nozzles 1539 so that they are in fluidic communication with the environment external to the synthetic jet ejector 1501. The first 1515, second 1517, third 1525 and fourth 1527 diaphragms form part of the walls of the central compartment 1505 and also form part of the walls of the first 1531, second 1533, third 1535 and fourth 1537 auxiliary compartments, respectively. Consequently, a first side of each of the first 1515, second 1517, third 1525 and fourth 1527 diaphragms is exposed to the atmosphere within the central compartment 1507, and a second side of each of the first 1515, second 1517, third 1525 and fourth 1527 diaphragms is exposed to, and in fluidic communication with, the atmosphere external to the central compartment 1507 and the synthetic jet ejector 1501 by way of the one or more apertures or nozzles 1539.

In operation, the first 1511, second 1513, third 1521 and fourth 1523 actuator coils are operated such that the volume of the central compartment 1507 remains essentially constant. This may be accomplished, for example, by operating these actuator coils in such a way that one pair of the first 1515, second 1517, third 1525 and fourth 1527 diaphragms are oscillated out of phase with each other, and such that the other pair of diaphragms are also oscillated out of phase with each other. For example, the first 1515 and second 1517 diaphragms may be oscillated in accordance with the time domain function f₁(t) while the third 1525 and fourth 1527 diaphragms are oscillated in accordance with the time domain function f₂(t), wherein f₁+f₂=0. Similarly, the first 1515 and third 1525 diaphragms may be oscillated in accordance with the function f₁(t) while the second 1517 and fourth 1527 diaphragms are oscillated in accordance with the function f₂(t), or the first 1515 and fourth 1527 diaphragms may be oscillated in accordance with the function f₁(t), while the second 1517 and third 1525 diaphragms are oscillated in accordance with the function f₂(t).

Alternatively, the first 1515 and second 1517 diaphragms may be oscillated in accordance with the time domain functions f₁(t) and −f₁(t), respectively, while the third 1525 and fourth 1527 diaphragms are oscillated in accordance with the time domain functions f₂(t) and −f₂(t), respectively. Similarly, the first 1515 and third 1525 diaphragms may be oscillated in accordance with the functions f₁(t) and −f₁(t), respectively, while the second 1517 and fourth 1527 diaphragms are oscillated in accordance with the functions f₂(t) and −f₂(t), respectively, or the first 1515 and fourth 1527 diaphragms may be oscillated in accordance with the functions f₁(t) and −f₁(t), respectively, while the second 1517 and third 1525 diaphragms are oscillated in accordance with the functions f₂(t) and −f₂(t), respectively.

The synthetic jet ejector 1501 of FIG. 15 is advantageous in that the central, hermetically sealed compartment 1507 seals the working components of the first 1503 and second 1505 synthetic jet actuators from the external environment, thus protecting them from contamination or degradation by dust, salt, moisture, chemicals and other environmental contaminants. On the other hand, the selective out-of-phase operation of actuator coils or diaphragms in the manner described above allows the central compartment 1507 to be sealed and of constant volume, without adversely affecting the operation of the synthetic jet ejector 1501. Indeed, this manner of operation may help to reduce or eliminate vibrations through the cancellation of momenta.

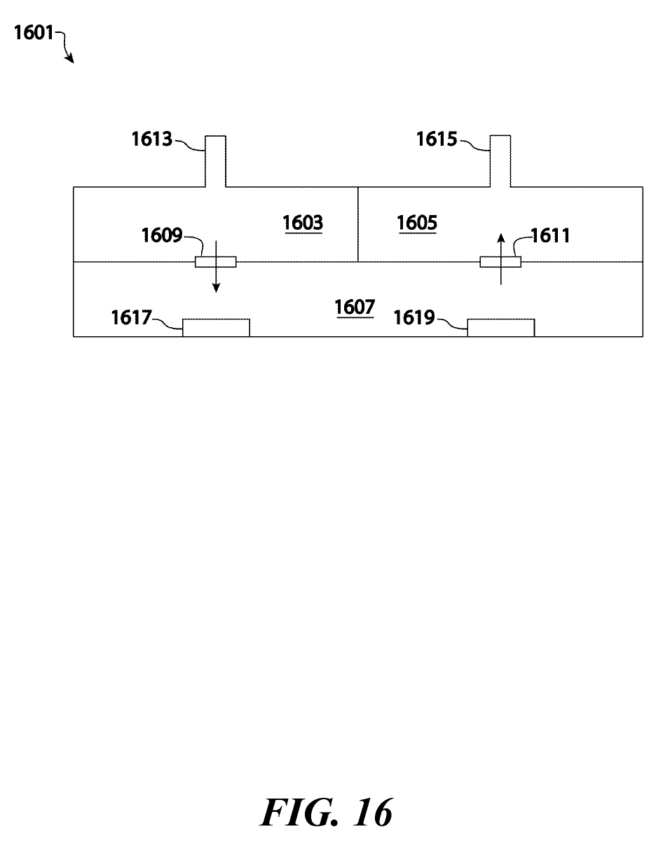

FIG. 16 illustrates another particular, non-limiting embodiment of a synthetic jet ejector in accordance with the teachings herein. In the embodiment depicted, the synthetic jet ejector 1601 comprises first 1603 and second 1605 actuator coils which are disposed in a common, hermetically sealed first compartment 1607. First 1609 and second 1611 magnets, respectively, are provided in opposing relation to the first 1603 and second 1605 actuator coils. The first 1609 and second 1611 magnets are embedded, respectively, in first 1613 and second 1615 diaphragms. The first diaphragm 1613 forms a partition between the first compartment 1607 and a second compartment 1617. Similarly, the second diaphragm 1615 forms a partition between the first compartment 1607 and a third compartment 1619. The second 1617 and third 1619 compartments are preferably fluidically isolated from each other and are equipped with first 1621 and second 1623 sets of nozzles or apertures, each of which contains at least one member.

In operation, the first 1603 and second 1605 actuator coils drive respective first 1613 and second 1615 diaphragms by creating an oscillating current that alternately attracts and repels respective magnets 1609 and 1611, the latter of which are preferably permanent magnets embedded in respective first 1613 and second 1615 diaphragms. The resulting vibrations in the first 1613 and second 1615 diaphragms cause ambient fluid to be periodically sucked into, and ejected from, the second 1617 and third 1619 compartments so as to create synthetic jets in the ambient fluid through entrainment of vortices as described above.

As with the synthetic jet ejector 1501 of FIG. 15, the synthetic jet ejector 1601 of FIG. 16 is advantageous in that the first (hermetically sealed) compartment 1607 seals the working components of the synthetic jet ejector 1601 from the external environment, thus protecting them from contamination or degradation by dust, salt, moisture, chemicals and other environmental contaminants. On the other hand, the selective, out-of-phase operation of actuator coils or diaphragms in the manner described above allows the first compartment 1607 to be sealed and of constant volume, without adversely affecting the operation of the synthetic jet ejector 1601. Moreover, this manner of operation may help to reduce or eliminate vibrations by providing at least some cancellation of momenta.

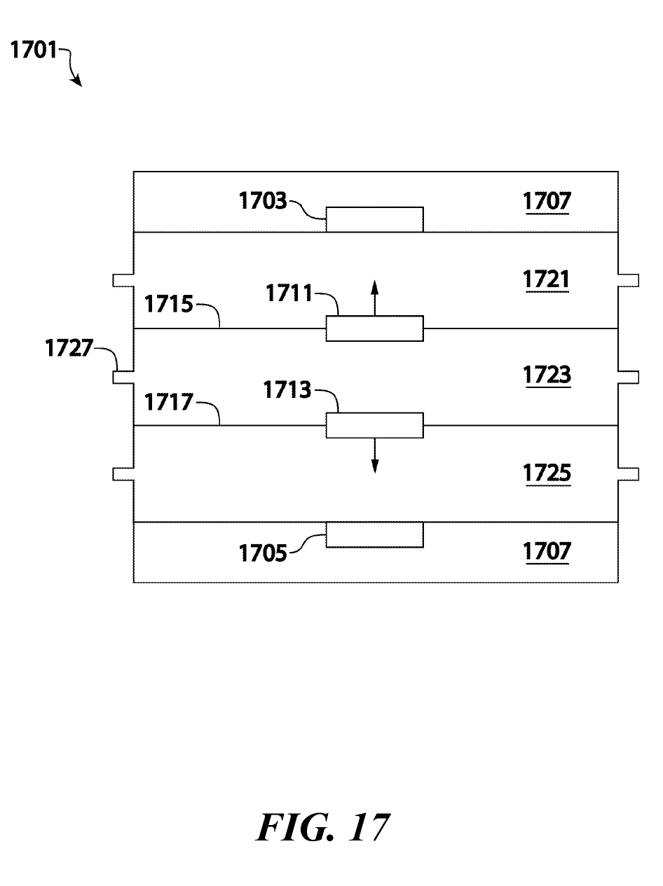

FIG. 17 illustrates another particular, non-limiting embodiment of a synthetic jet ejector in accordance with the teachings herein. In the embodiment depicted, the synthetic jet ejector 1701 comprises first 1703 and second 1705 actuator coils which are disposed, respectively, in first 1707 and second 1709 hermetically sealed compartments. First 1711 and second 1713 magnets, respectively, are provided in opposing relation to the first 1703 and second 1705 actuator coils. The first 1711 and second 1713 magnets are embedded, respectively, in first 1715 and second 1717 diaphragms. The first 1715 and second 1717 diaphragms divide the space between the first 1707 and second 1709 hermetically sealed compartments into third 1721, fourth 1723 and fifth 1725 compartments.

In operation, the first 1703 and second 1705 actuator coils drive respective first 1715 and second 1717 diaphragms by creating an oscillating current that alternately attracts and repels respective magnets 1711 and 1713, the latter of which are preferably permanent magnets embedded in respective first 1715 and second 1717 diaphragms. The resulting vibrations in the first 1715 and second 1717 diaphragms cause ambient fluid to be periodically sucked into, and ejected from, the third 1721, fourth 1723 and fifth 1725 compartments by way of nozzles or apertures 1727 so as to create synthetic jets in the ambient fluid through entrainment of vortices as described above.

As with the synthetic jet ejectors in some of the previously described embodiments, the synthetic jet ejector 1701 of FIG. 17 is advantageous in that the first 1707 and second 1709 (hermetically sealed) compartments seal the working components of the synthetic jet ejector 1701 from the external environment, thus protecting them from contamination or degradation by dust, salt, moisture, chemicals and other environmental contaminants. This is facilitated by the disposition of the magnets 1711 and 1713 in first 1715 and second 1717 diaphragms (which may be accomplished, for example, by insert molding), an arrangement which allows the actuator coils 1703 and 1705 of the synthetic jet ejector 1701 to be physically (but not magnetically) isolated from the magnets 1711 and 1713. This arrangement is further advantageous in that both surfaces of first 1715 and second 1717 diaphragms may be utilized to form synthetic jets. This arrangement is also advantageous in that operating the first 1715 and second 1717 diaphragms out of phase may help to reduce or eliminate vibrations by providing at least some cancellation of momenta.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A synthetic jet ejector, comprising:
a first actuator comprising a first diaphragm driven by a first actuator coil, wherein said first actuator coil is disposed on a first side of said first diaphragm;
a second actuator comprising a second diaphragm driven by a second actuator coil, wherein said second actuator coil is disposed on a first side of said second diaphragm; and
an airtight enclosure which encloses said first and second actuator coils;
wherein at least one of said first and second diaphragms is in fluidic communication with the environment external to said enclosure.

2. The synthetic jet ejector of claim 1, wherein at least one of said first and second diaphragms is in fluidic communication with the environment external to said synthetic jet ejector.

3. The synthetic jet ejector of claim 1, wherein both of said first and second diaphragms are in fluidic communication with the environment external to said enclosure.

4. The synthetic jet ejector of claim 1, wherein said first and second actuators operate out-of-phase.

5. The synthetic jet ejector of claim 1, wherein said first actuator further comprises a third diaphragm driven by a third actuator coil, and wherein said third actuator coil is disposed on a first side of said third diaphragm.

6. The synthetic jet ejector of claim 5, wherein said second actuator further comprises a fourth diaphragm driven by a fourth actuator coil, and wherein said fourth actuator coil is disposed on a first side of said fourth diaphragm.

7. The synthetic jet ejector of claim 6, wherein said first side of said first, second, third and fourth diaphragms are exposed to the atmosphere within said enclosure.

8. The synthetic jet ejector of claim 7, wherein said second side of said first, second, third and fourth diaphragms are exposed to the atmosphere outside of said enclosure.

9. The synthetic jet ejector of claim 7, wherein said second side of said first, second, third and fourth diaphragms are in fluidic communication with the atmosphere outside of said enclosure.

10. The synthetic jet ejector of claim 7, wherein said second side of said first, second, third and fourth diaphragms are in fluidic communication with the atmosphere outside of said enclosure by way of first, second, third and fourth respective apertures.

11. The synthetic jet ejector of claim 7, wherein said second side of said first, second, third and fourth diaphragms are in fluidic communication with the atmosphere outside of said enclosure by way of first, second, third and fourth respective sets of apertures, and wherein each of said first, second, third and fourth sets of apertures has a plurality of members.

12. The synthetic jet ejector of claim 7, wherein said second side of said first, second, third and fourth diaphragms are in fluidic communication with the atmosphere outside of said enclosure by way of first, second, third and fourth respective sets of nozzles.

13. The synthetic jet ejector of claim 5, wherein said first and third actuator coils have a first permanent magnet disposed between them.

14. The synthetic jet ejector of claim 13, wherein said first and third actuator coils are in contact with said first permanent magnet.

15. The synthetic jet ejector of claim 6, wherein said first and third actuator coils have a first permanent magnet disposed between them, and wherein said second and fourth actuator coils have a second permanent magnet disposed between them.

16. A method for operating the synthetic jet ejector of claim 6, wherein said first and third actuator coils are operated out-of-phase.

17. The method of claim 16, wherein said second and fourth actuator coils are operated out-of-phase.

18. The method of claim 16, wherein said first and second actuator coils are operated out-of-phase.

19. The method of claim 18, wherein said first and fourth actuator coils are operated in-phase.

20. The method of claim 19, wherein said second and third actuator coils are operated in-phase.

21. The synthetic jet ejector of claim 6, wherein said first side of said first, second, third and fourth diaphragms form part of the inner surface of said enclosure, wherein said second side of said first, second, third and fourth diaphragms are disposed, respectively, in first, second, third and fourth compartments and are in fluidic communication with the environment external to said synthetic jet ejector by way of at least one aperture.

22. A synthetic jet ejector, comprising:
a first diaphragm driven by a first actuator; and
a second diaphragm driven by a second actuator;
wherein said first and second actuators are disposed within a hermetically sealed compartment.

23. (canceled)

24. A synthetic jet ejector, comprising:
a first actuator which contains first and second voice coils and which is disposed in a hermetically sealed compartment;
a second actuator which contains third and fourth voice coils, and which is disposed in said hermetically sealed compartment;
first and second diaphragms which are driven by said first actuator and which are in fluidic communication with the ambient environment by way of respective first and second sets of orifices; and
third and fourth diaphragms which are driven by said second actuator and which are in fluidic communication with the ambient environment by way of respective third and fourth sets of orifices.

25. The synthetic jet ejector of claim 24, wherein said first actuator further contains a first permanent magnet.

26. The synthetic jet ejector of claim 24, wherein said second actuator further contains a second permanent magnet.

27-40. (canceled)
